(19) United States
(12) Patent Application Publication
(10) Pub. No.: US 2009/0236990 A1
(43) Pub. Date: Sep. 24, 2009

(54) ELECTRIC DISCHARGE LIGHT-REGULATION MATCHING...

(75) Inventor: Chao-Chin Yeh, Changhwa County (TW)

Correspondence Address: BROWDY AND NEIMARK, P.L.L.C.;624 NINTH STREET, NW, SUITE 300, WASHINGTON, DC, 20001-5303, US

(73) Assignee: Chuan Shih Industrial Co., Ltd., Tien Chung Township (TW)

(21) Appl. No.: 12/050,407

(22) Filed: Mar. 18, 2008

(51) Int. Cl. H01J 17/34

(52) U.S. Cl. 315/64

(57) ABSTRACT

A electric discharge light regulation matching circuit that operates with filaments includes a resonance unit, a converter unit, a charge circuit, a half-bridge output unit and a lamp. The converter unit is connected to the resonance unit to convert an AC current to a DC current. The charge circuit, which has a charge capacity, is connected to the converter unit. The half-bridge output unit includes two electric control switches in series connection. The lamp, which is connected to the charge circuit, includes a first filament and a second filament therein. The first filament has an end connected to the charge capacity to heat the first filament directly that may prevent a flicker problem of the lamp connecting the electric control switch and may provide functions of recycling power and preventing temperature rising.

### BACKGROUND OF THE INVENTION

1. Field of the Invention

The present invention relates to a gas discharge fluorescence lamp, and more particularly to a electric discharge light regulation matching circuit that operates with filaments.

2. Description of the Related Art

Typically, a conventional light-regulation type gas discharge fluorescent lamp or a conventional light-regulation type electronic ballast for fluorescent lamps utilizes IC chips and conventional standard light regulator having electric control switch, such as TRIAC, for light regulation. In a circuit thereof, there usually are a plurality of capacities, resistors and inductances. Typically, the gas discharge fluorescent lamp includes a lamp tube and a plastic case, in which the lamp tube is received.

However, in the process of light regulation, when the electric control switch is turned on, a pulse current of a few amperes is generated in charge of capacities. The pulse current is acted with inductances to generate a greater ringing wave, and its negative value usually exceeds the voltage of input power that causes turn-on and turn-off of the electric control switch and the flicker of the gas discharge fluorescent lamp. Therefore, there must be a damping resistor in the circuit to reduce the flicker caused by the ringing wave. However, this damping resistor will generate a great heat in operation that consumes the power and raises the temperature in the plastic case of the gas discharge fluorescent lamp.

### SUMMARY OF THE INVENTION

The primary objective of the present invention is to provide an electronic circuit that matches hot cathode fluorescent lamps to prevent the flicker problem of the electric control switch connecting light regulation lamp. The circuit includes an end of a filament connecting an end of a charge capacity to heat the filament directly. The circuit further has functions of reusing power and preventing temperature rising.

The secondary objective of the present invention is to provide a matching circuit for light regulation of a gas discharge fluorescent lamp, which may prevent the temperature rising in the plastic case.

To achieve the objectives of the present invention, a electric discharge light regulation matching circuit that operates with filaments includes a resonance unit, a converter unit, a charge circuit, a half-bridge output unit and a lamp. The resonance unit includes a first capacity and a second capacity in series connection, and including a first inductance in parallel connection with the first capacity and in series connection with the second capacity. The converter unit is connected to the resonance unit to convert an AC current to a DC current. The charge circuit includes at least a charge capacity connected to the converter unit. The half-bridge output unit includes two electric control switches in series connection, each of which has a control terminal connected to an oscillation unit respectively. The lamp, which is connected to the charge circuit, includes a first filament and a second filament therein, wherein the first filament has an end connected to the charge capacity to heat the first filament directly that may prevent a flicker problem of the lamp connecting the electric control switch and may provide functions of recycling power and preventing temperature rising.

### BRIEF DESCRIPTION OF THE DRAWINGS

FIG. 1 is a circuit diagram of a preferred embodiment of the present invention; and

FIG. 2 is a circuit diagram of the standard light regulator of the preferred embodiment of the present invention.

### DETAILED DESCRIPTION OF THE INVENTION

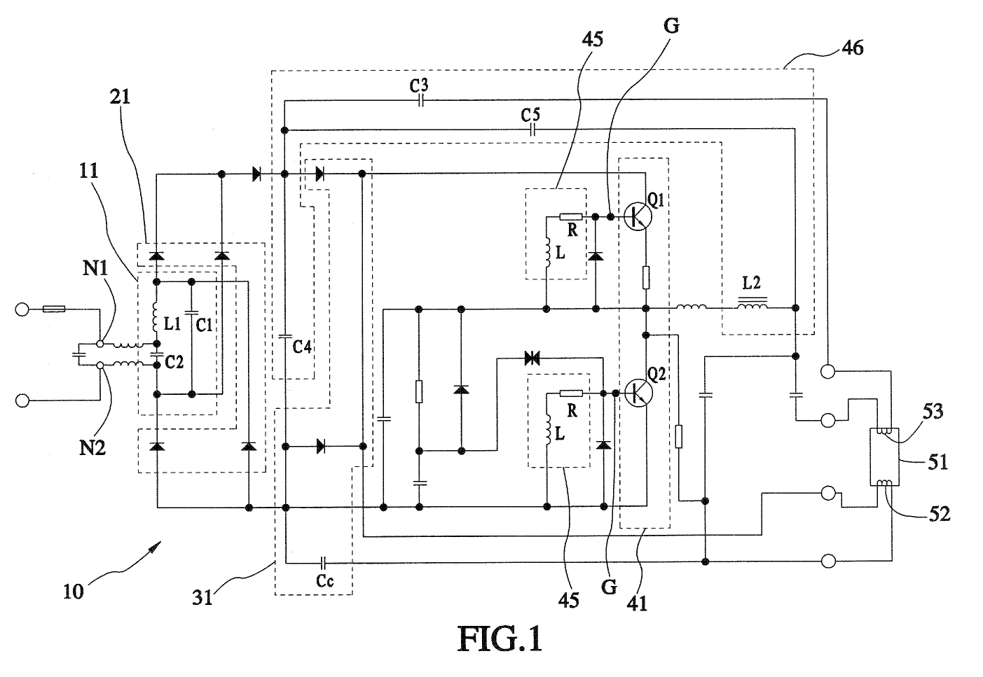

As shown in FIG. 1, a matching circuit 10 for light regulation of a hot cathode gas discharge fluorescent lamp which may match a standard light regulator to perform the function of light regulation. The matching circuit 10 includes a resonance unit 11, a converter unit 21, a charge circuit 31, a half-bridge output unit 41, and a lamp 51.

The resonance unit 11 includes a first capacity C1 and a second capacity C2 in series connection, and includes a first inductance L1 in parallel connection with the first capacity C1 and in series connection with the second capacity C2.

The converter unit 21 is connected to the resonance unit 11 to convert an AC current to a DC current. In the present invention, the converter unit 21 is a bridge rectifier.

The charge circuit 31 includes a charge capacity Cc connected to the converter unit 21.

The half-bridge output unit 41 includes two electric control switches Q1, Q2 in series connection and connected to the charge circuit 31. Each of the electric control switches Q1, Q2 has a control terminal G, and each of the control terminals G is connected to an oscillation unit 45. In the present invention, the electric control switches Q1, Q2 are transistors, and the oscillation units 45 are RL oscillating circuits including a resistor R and an inductance L in series connection.

A voltage feedback unit 46, which is connected to the charge circuit 31, includes a second inductance L2 and three capacities C3, C4, and C5.

The characters of the present invention are that the lamp 51, which is connected to the charge circuit 31, has two filaments 52, 53 therein, wherein an end of the first filament 52 is connected to an end of the charge capacity Cc, therefore, the first filament 31 works as a damping resistor of the charge circuit 31. An end of the second filament 53 is connected to the voltage feedback unit 46. In the present invention, the lamp 51 is a gas discharge fluorescent lamp having a plastic case (not shown). The matching circuit 10 of the present invention is provided in the plastic case, and the lamp 51 is left out of the plastic case. The plastic case of the gas discharge fluorescent lamp is a conventional element, so we do not describe the detail here.

The operation of the present invention is described in following:

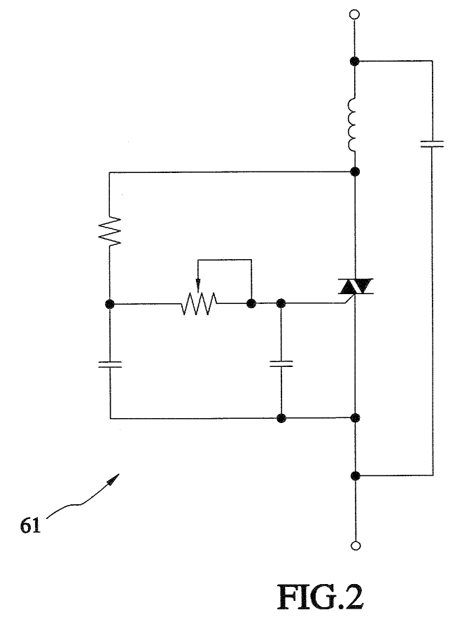

In operation, the matching circuit 10 of the present invention is connected to a standard light regulator 61, as shown in FIG. 2. The standard light regulator 61 is connected to a power input ends N1, N2 of the resonance unit 11 to adjust the brightness of the lamp via the standard light regulator 61. The standard light regulator 61 is a conventional device, so we do not describe the detail here.

When power inputting, the power go through the resonance unit 11, the converter unit 21, the charge circuit 31 and the half-bridge output unit 41 to charge the charge capacity Cc and to light the lamp 51.

In light regulation, to adjust the lamp 51 from dark to bright, the input power is dropping gradually and generates a “ringing” effect that causes a great ringing wave. As a result, the first filament 52 works as the damping resistor to reduce the ringing wave. In the same time, the heat generated by the ringing wave acting on the first filament 52 may heat the filament 52 itself for heat recycling. In addition, the filament, which may replace the damping resistor, may prevent the damping resistor heating in the plastic case that the temperature in the plastic case may be kept in a normal condition.

In conclusion, the functions of the present invention are:

1. Recycling the waste power: the present invention provides the filament of the lamp working as the damping resistor to fix the problems of connecting the electric control switch. The present invention further recycles the power wasting in the damping resistor to reuse on the filament that provides an efficient use of power.

2. Preventing temperature in the plastic case rising of the gas discharge fluorescent lamp: Because the present invention provides the filament replacing the damping resistor, there is no need to provide the damping resistor in the circuit that no heating problem will occur. As a result, the temperature in the plastic case, in which the circuit is received, may be kept in a normal condition.

Although a particular embodiment of the invention has been described in detail for purposes of illustration, various modifications and enhancements may be made without departing from the spirit and scope of the invention. Accordingly, the invention is not to be limited except as by the appended claims.

1. An electric discharge light regulation matching circuit that operates with filaments, comprising:
a resonance unit including a first capacity and a second capacity in series connection, and including a first inductance in parallel connection with the first capacity and in series connection with the second capacity;
a converter unit connected to the resonance unit to convert an AC current to a DC current;
a charge circuit including at least a charge capacity connected to the converter unit;
a half-bridge output unit including two electric control switches in series connection, each of which has a control terminal connected to an oscillation unit respectively;
a lamp, which is connected to the charge circuit, including a first filament and a second filament therein, wherein the first filament has an end connected to the charge capacity to heat the first filament directly in order to prevent a flicker problem of the lamp connecting the electric control switch and to provide functions of recycling power and preventing temperature rising.

2. The electric discharge light regulation matching circuit that operates with filaments as claimed in claim 1, further comprising a voltage feedback unit connected to the charge circuit, wherein the second filament of the lamp has an end connected to the voltage feedback unit.

3. The electric discharge light regulation matching circuit that operates with filaments as claimed in claim 2, wherein the voltage feedback unit has a second inductance and two capacities in series connection.

4. The electric discharge light regulation matching circuit that operates with filaments as claimed in claim 1, wherein the converter unit is a bridge rectifier.

5. The electric discharge light regulation matching circuit that operates with filaments as claimed in claim 1, wherein each of the electric switches is a transistor.

6. The electric discharge light regulation matching circuit that operates with filaments as claimed in claim 1, wherein each of the oscillation units is a RL oscillating circuit having a resistor and an inductance in series connection.

7. The electric discharge light regulation matching circuit that operates with filaments as claimed in claim 1, wherein the end of the first filament connected to the charge capacity is connected directly to the charge capacity.
